(19) United States
(12) Patent Application Publication
(10) Pub. No.: US 2010/0075708 A1
(43) Pub. Date: Mar. 25, 2010

(54) Method and system for notifying absence in PTT service, and portable terminal adapted thereto

(75) Inventors: Sun Mi Hong, Gumi-si (KR); Woo Chan Park, Daegu Metropolitan City (KR)

Correspondence Address: DOCKET CLERK, P.O. DRAWER 800889, DALLAS, TX, 75380, US

(73) Assignee: Samsung Electronics Co., Ltd., Suwon-si (KR)

(21) Appl. No.: 12/586,369

(22) Filed: Sep. 21, 2009

(30) Foreign Application Priority Data
Sep. 22, 2008 (KR) 10-2008-0092568

(51) Int. Cl. H04B 7/00

(52) U.S. Cl. 455/518

(57) ABSTRACT

A method and system for notifying a first portable terminal regarding the absence of a second terminal in a Push-To-Talk (PTT) service. The system allows a first portable terminal user to transmit an absence notifying message to the second portable terminal user, and displays an absent state of the first portable terminal user when the second portable terminal user requests a PTT connection with the first portable terminal user. Therefore, the system enables the second portable terminal user to recognize the absent state of the first portable terminal user.

### CROSS-REFERENCE TO RELATED APPLICATION(S) AND CLAIM OF PRIORITY

The present application is related to and claims priority to an application entitled “METHOD AND SYSTEM FOR NOTIFYING ABSENCE IN PTT SERVICE, AND PORTABLE TERMINAL ADAPTED THERETO” filed in the Korean Intellectual Property Office on Sep. 22, 2008 and assigned Serial No. 10-2008-0092568, the contents of which are incorporated herein by reference.

### TECHNICAL FIELD OF THE INVENTION

The present invention relates to communication systems, and more particularly, to a system that enables a portable terminal user to transmit an absence notifying message to the other user's portable terminal user, in a push-to-talk service, and displays an absent state of the portable terminal user when the other portable terminal user requests a push-to-talk connection from the portable terminal user, thereby letting the other portable terminal user recognize the absent state of the portable terminal user.

### BACKGROUND OF THE INVENTION

In general, Push-To-Talk (PTT) is similar to communication of walkie-talkie where a conversation is performed between a user and the other user by using a button to switch from voice reception mode to transmission mode. In recent years, a PTT communication service has been introduced where respective portable terminals have unique Internet protocol (IP) addresses and this allows for a one-to-one or one-to-many call using Voice Over IP (VoIP).

A PTT communication service starts when a calling portable terminal requests a PTT connection with a called portable terminal. The PTT communication request can be achieved by pressing a PTT key. When the called portable terminal receives a PTT connection request, the called portable terminal notifies a called user of the reception of the PTT connection request and then displays subscriber information regarding the calling portable terminal, i.e., call number, name, and image, and so forth on its screen. The called portable terminal user recognizes the PTT connection request and accepts the PTT connection, so that he/she can make a PTT call with the calling portable terminal user.

If the called portable terminal user is absent and does not reply to the PTT connection request within a certain period of time that has elapsed, the PTT connection request of the calling portable terminal is terminated. Therefore, the conventional communication system using a PTT service is disadvantageous in that, since the calling portable terminal user attempts a PTT connection without recognizing the absent state of the called portable terminal user, he/she must waste time making the PTT connection attempt and pay a communication charge corresponding to communication with a PTT server according to the PTT connection request.

### SUMMARY OF THE INVENTION

To address the above-discussed deficiencies of the prior art, it is a primary object to provide a method that allows a portable terminal user to transmit his/her absent state to the other portable terminal user so as to prevent the other portable terminal user from requesting a PTT connection from the portable terminal user when the portable terminal user is absent.

In accordance with an exemplary embodiment of the present invention, the present invention provides a method for notifying an absent state in a PTT service, including: transmitting an absence notifying message from a first portable terminal to at least one or more second portable terminals if a phone number the same as a phone number of a incoming call is not stored in a phone book; setting subscriber information regarding the first portable terminal to an absent state in the second portable terminal having received the absence notifying message; and displaying the absent state of the first portable terminal in the second portable terminals if the user of the second portable terminal requests a connection from the first portable terminal.

In some advantageous embodiments, the process of setting subscriber information regarding the first portable terminal to an absent state, includes: searching for subscriber information regarding the user of the first portable terminal in the second portable terminal; and updating an absent state data of the searched subscriber information based on the received absence notifying message.

In some advantageous embodiments, the method further includes displaying the absence reason and the absence time period.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a view of a network of a system for providing a push-to-talk (PTT) service;

FIG. 2 illustrates a schematic block diagram of a portable terminal adapted to a method for notifying absence, according to an embodiment of the present invention;

FIG. 3 illustrates a flow chart describing a method for generating an absence notifying message in a portable terminal, according to an embodiment of the present invention;

FIG. 4 illustrates a flow chart describing a method for setting subscriber information regarding a caller's portable terminal to an absent state by a portable terminal having received an absence notifying message, according to an embodiment of the present invention;

FIG. 5 illustrates a flow chart describing an operating method of a portable terminal if the portable terminal requests a push-to-talk connection from the other portable terminal set to an absent state, according to an embodiment of the present invention;

FIG. 6A illustrates a flow chart describing a method for storing an IP address of the called portable terminal by a PTT server when an absence notifying message is transmitted, according to an embodiment of the present invention;

FIG. 6B illustrates a flow chart describing a method for releasing an absent state by a portable terminal having transmitted an absence notifying message, according to an embodiment of the present invention; and

FIG. 7A to FIG. 7E illustrate screens displaying processes as an absent state of a PTT service is notified, according to an embodiment of the present invention.

### DETAILED DESCRIPTION OF THE INVENTION

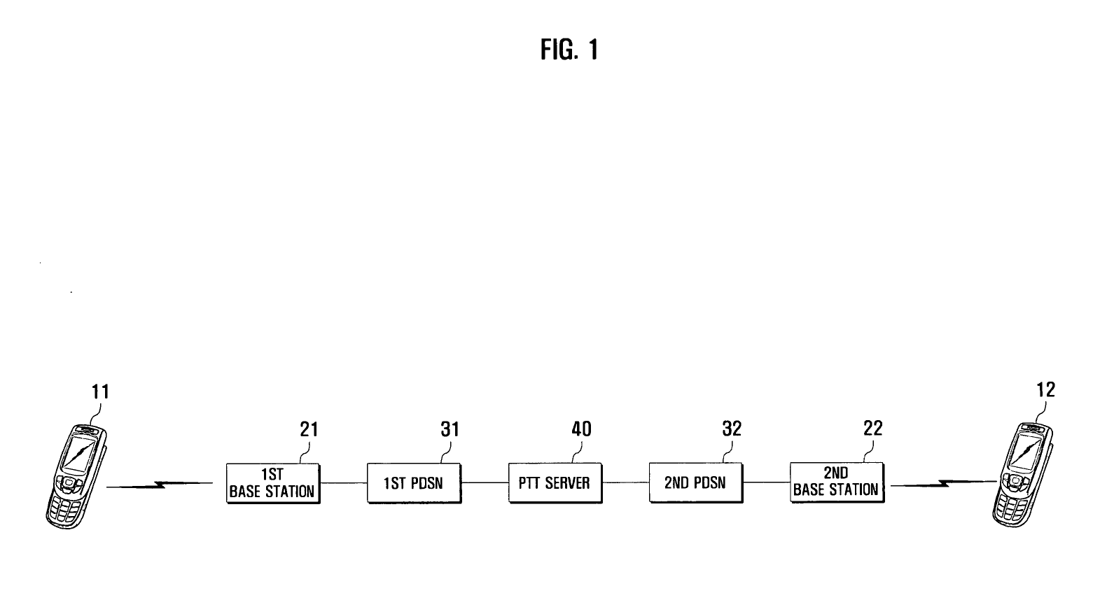

FIGS. 1 through 7E, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless communications network.

The terms or words described in the present description and the claims should not be limited by a general or lexical meaning, instead should be analyzed as a meaning and a concept through which the inventor defines and describes the present invention at his most effort, to comply with the idea of the present invention. Therefore, one skilled in the art will understand that the embodiments disclosed in the description and configurations illustrated in the drawings are only preferred embodiments, instead there may be various modifications, alterations, and equivalents thereof to replace the embodiments at the time of filing this application.

In an embodiment of the present invention, subscriber information refers to general information that a portable terminal user can use to recognize other portable terminal users. Examples of the subscriber information are subscriber's name, company name, telephone, group name, and so forth. In particular, the subscriber information includes the absence reason and absence time period. The subscriber information can indicate whether a user is absent.

An absence notifying message refers to a message that is transmitted to all of the other portable terminal users, who subscribed a PTT service, to notify them of an absent state of a portable terminal user. The absence notifying message is stored in a group or a portable terminal of the other portable terminal user, which is designated by the portable terminal user. The absence notifying message includes an absence reason and an absence time period.

An absence releasing message refers to a message that is transmitted from the portable terminal user (i.e., sender) who transmitted an absence notifying message to the other portable terminal users (i.e., receivers) to notify them that the portable terminal user released his/her absent state.

A menu for notifying a state in absence refers to an interface used to generate an absence notifying message or an absence releasing message.

An absent state indication displays an absent state of the other portable terminal on a display unit of a portable terminal, with a pop-up window, when the portable terminal user requests a connection from the other portable terminal user, so that the portable terminal user recognizes the absent state of the other portable terminal user. It will be appreciated that any type of events, such as an alarm sound, vibration, and the like, can be used for absent state indication, provided that they can serve to allow a portable terminal user to recognize the absent state of the other portable terminal user.

FIG. 1 illustrates a view of a network of a system for providing a push-to-talk (PTT) service.

Referring to FIG. 1, the system includes a plurality of portable terminals 11 and 12, a plurality of base stations 21 and 22, a plurality of Packet Data Serving Nodes (PDSNs) 31 and 32, and a PTT server 40.

The plurality of portable terminals 11 and 12 are located within service ranges of the base stations 21 and 22 and receive signals from the base stations 21 and 22, respectively. The portable terminals 11 and 12 also receive voice signals or data from subscribers and transmit them to the base stations 21 and 22, correspondingly and respectively. In particular, the portable terminals 11 and 22 generate an absence notifying message and an absent state releasing message and transmit them to the base stations. If one of the portable terminals 11 and 12 receives an absence notifying message, it searches for subscriber information regarding the other portable terminal, which transmitted the absence notifying message, from its memory and then changes the current state of the other portable terminal to an absent state. If one of the portable terminal 11 and 12, which received an absence notifying message, request a PTT connection from the other portable terminal that transmitted the absence notifying message, the portable terminal having received the absence notifying message outputs the absent state indication of the other portable terminal so as to prevent the portable terminal user from requesting a connection with the other portable terminal user.

The base stations 21 and 22 receive signals, such as an absence notifying message and an absence releasing message, from the portable terminals 11 and 12 within a corresponding service cell, respectively, and transmit them to the PDSNs 31 and 32 over a wired network. The base stations 21 and 22 also receive signals from the PDSNs 31 and 32, and wirelessly transmit them to the portable terminals 11 and 12 within a corresponding service cell, respectively. The base stations 21 and 22 allocate wireless channels for the portable terminals 11 and 21 within a service cell, respectively, and then release them. The base stations 21 and 22 also process the hand-off to secure the mobility of the portable terminals 21 and 22, respectively. The base stations 21 and 22 convert analog signals, from the portable terminals 11 and within a service cell, into digital signals that can be transmitted via E1/T1 circuit class, and then transmit them to the PDSNs 31 and 32j, respectively, via a wired network. The base stations 21 and 22 also convert digital signals, from the PDSNs 31 and 32, into analog signals, and then transmit them to the portable terminals 11 and 12, respectively.

Each of the plurality of PDSNs 31 and 32 converts digital signals, received via a wired network, into IP packets that can be transmitted over an IP network, respectively. The PDSNs 31 and 32 also convert IP packets, received via an IP network, into digital signals and then transmit them to the base stations, respectively, via a wired network.

A network is called an Access Network (AN) that includes the portable terminals 11 and 12, located within a service cell of the base stations 21 and 22 respectively, and the PDSNs 31 and 32 connected via a wired network to the base stations 21 and 22 respectively.

The PTT server 40 receives IP packets from the respective PDSNs 31 and 32, and analyzes them. It also connects between the portable terminals 11 and 12 and provides a PTT service to them. In particular, the PTT server 40 stores an absent state of a portable terminal user and an IP address of a called portable terminal when it receives an absence notifying message from the portable terminals 11 and 12. After that, if the PTT server 40 receives an absence releasing message from the portable terminal having transmitted the absence notifying message, it transmits the absence releasing message to the called portable terminal whose IP address was stored.

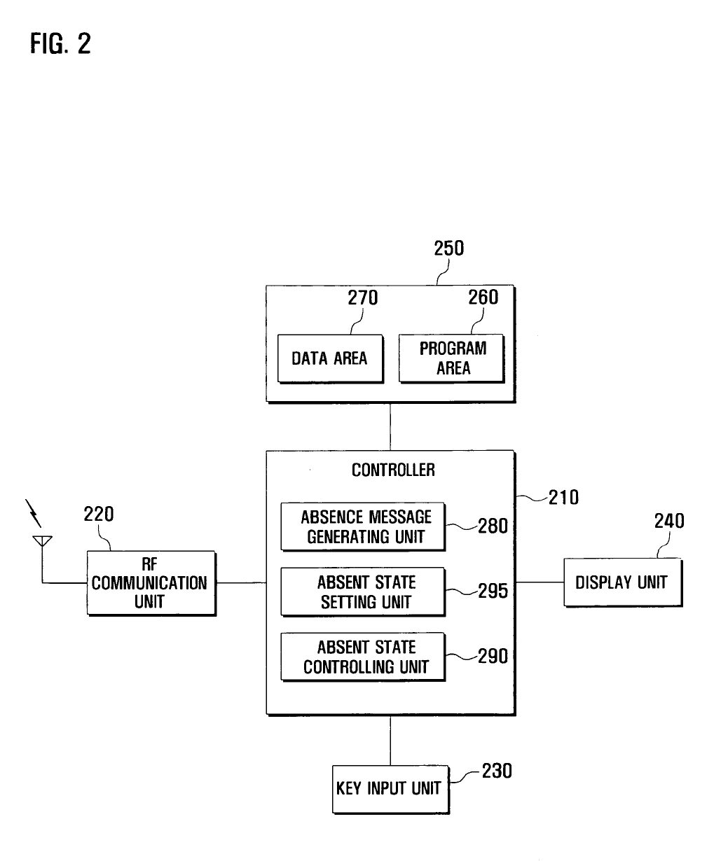

FIG. 2 illustrates a schematic block diagram of a portable terminal adapted to a method for notifying absence, according to an embodiment of the present invention.

Referring to FIG. 2, the portable terminal includes a controller 210, an RF communication 220, a key input unit 230, a display unit 240, and a memory 250.

The RF communication 220 allows its portable terminal to communicate with the other portable terminals via a base station in RF communication. For example, the RF communication 220 transmits/receives voice data, text message, multimedia message, and so forth via a communication network. In particular, in an embodiment of the present invention, the RF communication 220 transmits/receives an absence notifying message/an absence releasing message, which is generated by an absence message generating unit 280 of the controller 210.

The display unit 240 displays states and results according to a series of operations, a variety of information, etc., under the control of the controller 210. The display unit 240 may be implemented with a display device, such as an LCD, an Organic Light Emitting Diodes (OLED), and the like. In particular, the display unit 240 can display an absent state indication that is transmitted from the controller 210 if the portable terminal user attempts a PTT connection with the other portable terminal user who is in an absent state.

The key input unit 230 is implemented with a general key pad. It may be also implemented with a touch screen, a touch pad, or a scroll wheel. The key input unit 230 receives commands for controlling the portable terminal from the user and then outputs signals corresponding to the commands to the controller 210. In particular, the key input unit 230 receives an absence reason and an absence time period, contained in an absence notifying message, from the user, converts them into electrical signals, and then outputs them to the controller 210.

The memory 250 includes a program area 260 and a data area 270. The program area 260 stores application programs for controlling the operations of the portable terminal. The data area 270 temporarily stores data generated as the programs are executed. In particular, the data area 270 stores subscriber information. The subscriber information is composed of fields of subscriber name, a variety of phone numbers, and so forth, as shown in following Table 1. In particular, the subscriber information contains a field for indicating an absent state, fields for storing an absence reason and an absence time period.

TABLE 1

Name
Portable terminal phone number
Home telephone number
Office telephone number
Fax number
Other numbers
Group
Absent state <Boolean Type>
Absence reason <Boolean Type>
Absence time period <Boolean Type>

The controller 210 controls the operations of the portable terminal. The controller 210 includes an absence message generation unit 280, an absent state controlling unit 290, and an absent state setting unit 295.

The absence message generation unit 280 receives an absence reason and absence time period that a portable terminal user input through the key input unit 230 if the portable terminal user wishes to inform the other subscriber of his/her absent state, and generates an absence notifying message. The absence message generating unit 280 also generates an absence releasing message if the portable terminal generated an absence notifying message.

The absent state controlling unit 290 searches for subscriber information of the other portable terminal user from the data area 270 of the memory 250 if the portable terminal user requests a PTT connection from the other portable terminal user, and then confirms that the other portable terminal user corresponding to the searched subscriber information is absent. If the absent state controlling unit 290 ascertains that the other portable terminal user is absent, it checks the absence time period included in the subscriber information that is searched from the data area 270. If the absence time period has not elapsed, the absent state controlling unit 290 concludes that the other portable terminal user is absent and then displays the absent state indication to the portable terminal user.

The absent state setting unit 295 receives an absence notifying message, searches for subscriber information of a portable terminal having transmitted the absence notifying message from the data area 270, and then changes the searched subscriber information to an absent state. That is, the absent state field is set to ‘1.’ The absent state field of the pieces of subscriber information is, in general, set by a Boolean type. In an embodiment of the present invention, although an absent state is indicated by ‘1,’ it will be easily appreciated that it can be indicated by ‘0.’ The absent state setting unit 295 extracts data of an absence reason and an absence time period from the received absence notifying message and then inputs them in the absence reason field and the absence time period field of the subscriber information whose state is changed to be an absent state. The data recorded in the absence reason field and the absence reasons are exampled in following Table 2. It should be understood that there may be many other absence reasons, and they can be directly input by users.

TABLE 2

| Data | Absence reason |
|---|---|
| 00 | In meeting |
| 01 | On vacation |
| 10 | working |
| 11 | Miscellaneous |

The absent state setting unit 295 receives an absence releasing message from the other portable terminal having transmitted an absence notifying message, and then releases the absent state included in the subscriber information of the other portable terminal user. Setting and releasing of an absent state by the absent state setting unit 295 occur while portable terminal users do not perceive (automatically). Therefore, although a portable terminal user does not directly set or release an absent state of the other portable terminal user, the portable terminal receives an absence notifying message and an absence releasing message, and changes data of the absent state field for subscriber information to a corresponding state. Therefore, if the portable terminal user requests a PTT connection from the other portable terminal user in absence, the absent state setting unit 295 outputs an absent state indication, so that the portable terminal user can detect the absent state of the other portable terminal user.

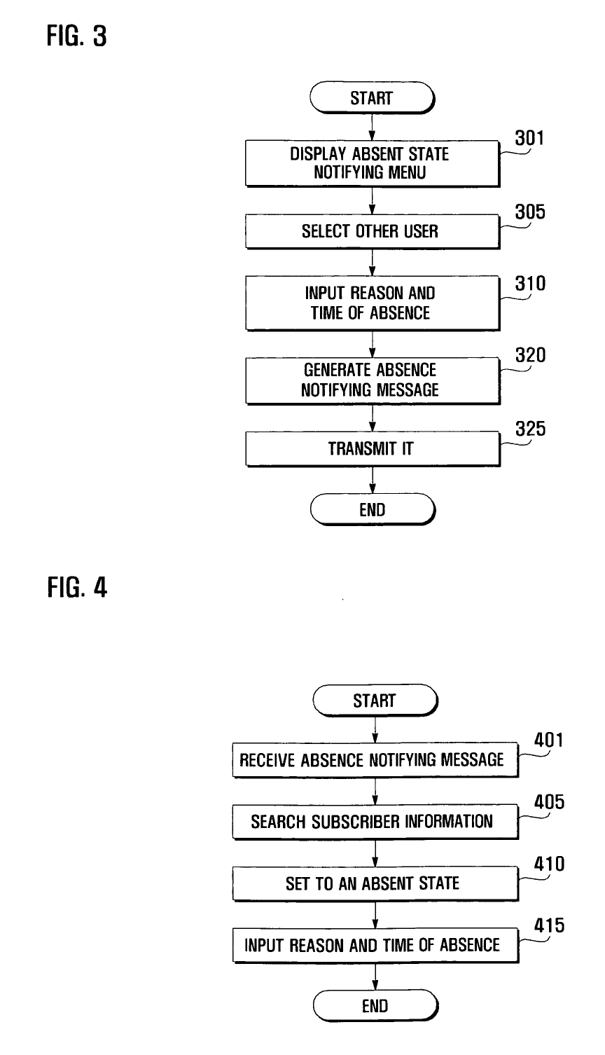

FIG. 3 illustrates a flow chart describing a method for generating an absence notifying message in a portable terminal, according to an embodiment of the present invention.

Referring to FIG. 3, the portable terminal displays an absent state notifying menu according to a user's selection (step 301).

The portable terminal user selects other users in order to transmit an absence notifying message thereto (step 305). In an embodiment of the present invention, other users may be a particular one or a plurality of the subscribers who subscribe to a PTT service, who is/are designated by the portable terminal user. In particular, the portable terminal user selects one group of the subscribers, and then transmit an absence notifying message and an absence releasing message to all members of the selected group at a time. The portable terminal user transmits an absence notifying message to a plurality of service subscribers.

The user inputs an absence reason and an absence time period (step 310). An absence reason can be either selected from the data described in Table 2 or may be directly input. The portable terminal user inputs an absence time period according to his/her input absence reason, where the portable terminal's absent state corresponding to the absence time period will be last in the other portable terminal.

The absence message generating unit 280 of the controller 210 generates an absence notifying message that includes information regarding the selected other user, an absence reason, and an absence time period (step 320).

The controller 210 outputs the generated absence notifying message to its RF communication 220, and the RF communication 220 transmits it to the base station (step 325).

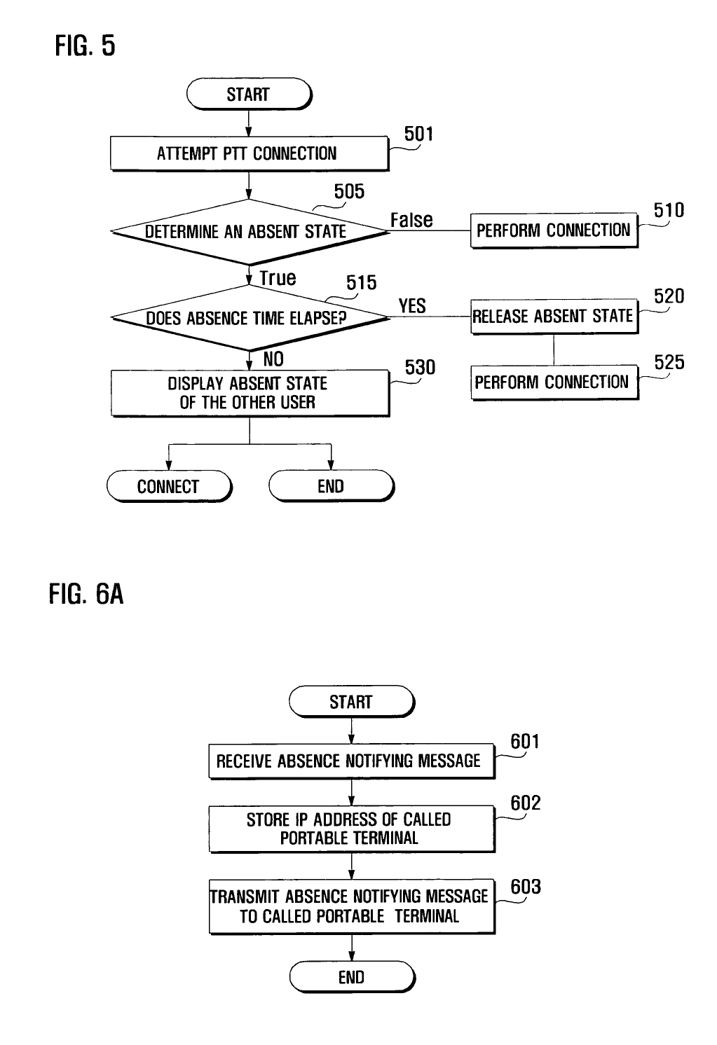

FIG. 4 illustrates a flow chart describing a method for setting subscriber information regarding a caller's portable terminal to an absent state by a portable terminal having received an absence notifying message, according to an embodiment of the present invention.

Referring to FIG. 4, a portable terminal receives an absence notifying message from the other portable terminal through a PTT server (step 401). The portable terminal searches for the subscriber information of the other user, who has transmitted the absence notifying message through the other portable terminal, from the data area of the memory (step 405). The portable terminal sets the searched subscriber information to an absent state (step 410). In an embodiment of the present invention, an absent state can be indicated in such a way that subscriber information generates an absent state field and inputs data therein. It will be understood that any type of indication can be employed if it can allow the portable terminal user to recognize the absent state of the other portable terminal user by adding data to subscriber information.

After that, an absence reason and an absence time period are input to the searched subscriber information (step 415). Although the portable terminal user does not recognizes the absent state of the other portable terminal user, the portable terminal having received an absence notifying message sets the subscriber information regarding the other portable terminal user, stored in the memory of the portable terminal, to an absent state and the inputs information according to the absent state thereto.

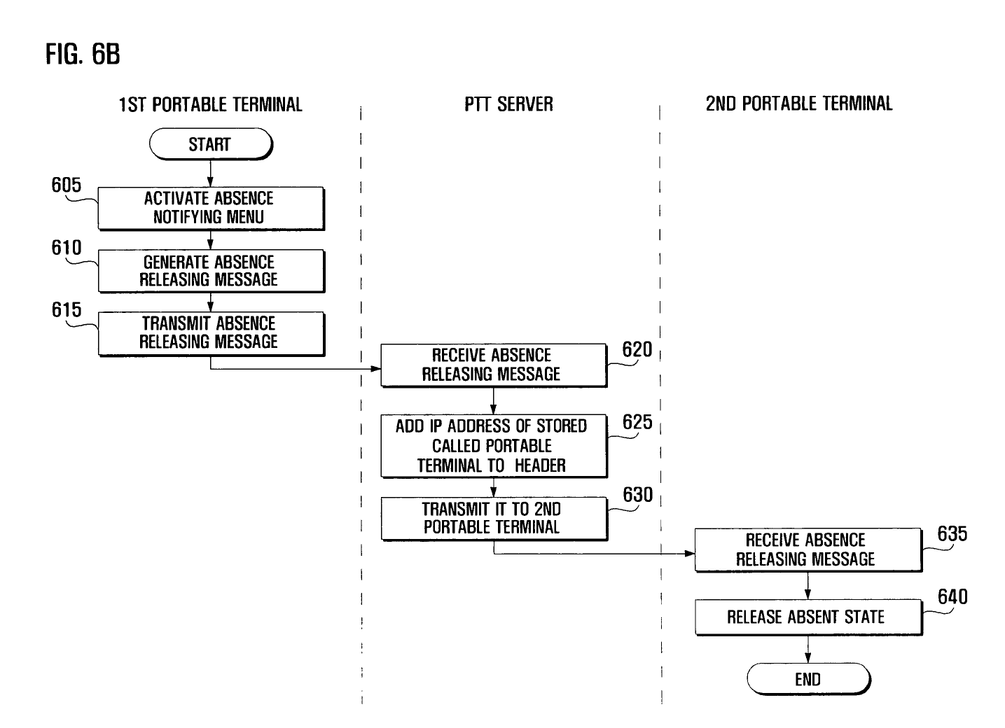

FIG. 5 illustrates a flow chart describing an operating method of a portable terminal if the portable terminal requests a PTT connection from the other portable terminal that has been set to an absent state, according to an embodiment of the present invention.

Referring to FIG. 5, a portable terminal user attempts to PTT connection to a particular other user or a particular group (step 501). In that case, the absent state controlling unit of the controller of the portable terminal identifies subscriber information of the other users for the PTT connection, and then determines whether the subscriber information of the other users is set to an absent state (step 505). That is, the absent state controlling unit receives an absence notifying message to determine whether the target of the PTT connection is the other users whose subscriber information is set to an absent state. If the absent state controlling unit ascertains that the subscriber information of the other users is not set to an absent state at 505, it allows the portable terminal to be connected with the other portable terminal, based on a PTT service (step 510).

Conversely, if the absent state controlling unit ascertains that the subscriber information of the other users is set to an absent state at 505, it determines whether an absence time period of the subscriber information has elapsed (step 515). If the absent state controlling unit ascertains that an absence time period has elapsed at 515, the absent state setting unit of the controller releases the absent state of the subscriber information regarding the other portable terminal user (step 520). That is, although the subscriber information regarding the other portable terminal is set to an absent state and the portable terminal does not receive an absence releasing message from the other portable terminal if the absence time period has elapsed, the portable terminal releases the absent state of the subscriber information regarding the other portable terminal and request a connection from the other portable terminal (step 525). That is, the portable terminal is connected to the other portable terminal based on a PTT service.

Conversely, if the absent state controlling unit ascertains that an absence time period has not elapsed at 515, it displays that the other portable terminal is in an absent state (step 530). That is, when the portable terminal user requests a PTT connection from the other portable terminal user, the absent state controlling unit displays a pop-up window showing the absent state of the other portable terminal user, so as to have the portable terminal user recognize the absent state, and outputs that it cannot provide the service. The absent state indication regarding the other portable terminal user includes the absence reason and the absence time period that is included in a previously received absence notifying message. Therefore, the portable terminal user ascertains the absent state indication of the other portable terminal user and concludes that the other portable terminal user is in an absent state. Accordingly, the portable terminal user cancels the PTT connection request currently intended to be attempted to the other portable terminal user and thus save. Furthermore, the portable terminal can avoid communicating with a PTT server since it does not need to request a PTT service connection therefrom.

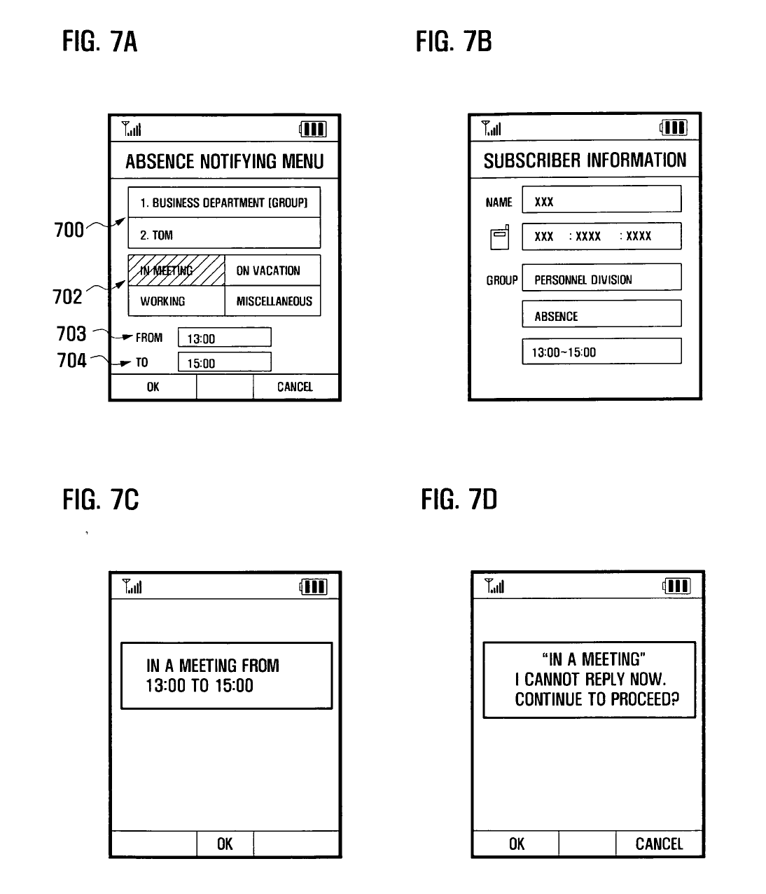

FIG. 6A illustrates a flow chart describing a method for storing an IP address of the called portable terminal by a PTT server when an absence notifying message is transmitted, according to an embodiment of the present invention.

Referring to FIG. 6A, a PTT server receives an absence notifying message generated by and transmitted from a portable terminal (step 601). More specifically, when a portable terminal transmits an absence notifying message to a base station, the base station converts it into a digital signal that can be transmitted via an E1/T1 class circuit and then transmits it to a PDSN. The PDSN converts the received digital signal into an IP packet and transmits it to the PTT server via an IP network.

The PTT server analyzes the absence notifying message in the format of IP packet, extracts an IP address of a called portable terminal, and stores it (step 602). During this stage, the PTT server may also extract data, corresponding to the absent state of the caller portable terminal, and the absence reason and absence time period, included in the absence notifying message, and may then store them. The PTT server transmits the absence notifying message to the called portable terminal, i.e., the other portable terminal (step 603). More specifically, when the PTT server transmits the absence notifying message in the format of IP packet to a PDSN, the PDSN converts the received signal into a digital signal and transmits it to a base station. The base station converts the received digital signal into an analog signal and then transmits it to the called portable terminal.

FIG. 6B illustrates a flow chart describing a method for releasing an absent state by a portable terminal having transmitted an absence notifying message, according to an embodiment of the present invention.

Referring to FIG. 6B, the portable terminal having transmitted an absence notifying message activates an absence notifying menu as the process of generating an absence notifying message (step 605). The portable terminal generates an absence releasing message (step 610). Unlike the process of generating an absence notifying message, the portable terminal user does not need to input an absence reason and the absence time period nor designate the other portable terminal user when the absence releasing message is generated. This is because the PTT server already has stored information regarding the called portable terminal when an absence notifying message is transmitted. The portable terminal transmits the absence releasing message to the PTT server using the same method as the process of transmitting an absence notifying message (step 615).

The PTT server receives the absence releasing message from the portable terminal (step 620). Since the received absence releasing message does not have information regarding the called portable terminal, the PTT server adds the IP address of the called portable terminal, stored in the process of transmitting an absence notifying message, to the received absence releasing message (step 625). The PTT server transmits the absence releasing message to the called portable terminal that has received the absence notifying message and has set subscriber information regarding the portable terminal user to an absent state (step 630).

The called portable terminal receives the absence releasing message from the PTT server (step 635). The called portable terminal analyzes the absence releasing message, searches for subscriber information regarding the caller portable terminal from the memory, and releases the absent state of the searched subscriber information (step 640).

In an embodiment of the present invention, the method of the present invention is implemented in such a way that the IP address of the other portable terminal is stored in the PTT server when the absence notifying message is transmitted, and, based thereon, the absent state releasing operation is performed.

However, it should be understood that the embodiment may be modified in such a way that the IP address of the other portable terminal is stored in the memory of the portable terminal when the absence notifying message is transmitted, and automatically added to an absence releasing message when the absence releasing message is generated. In this modification, the PTT server serves to relay the absence notifying message and the absence releasing message from the caller portable terminal (portable terminal) to the called portable terminal (other portable terminal).

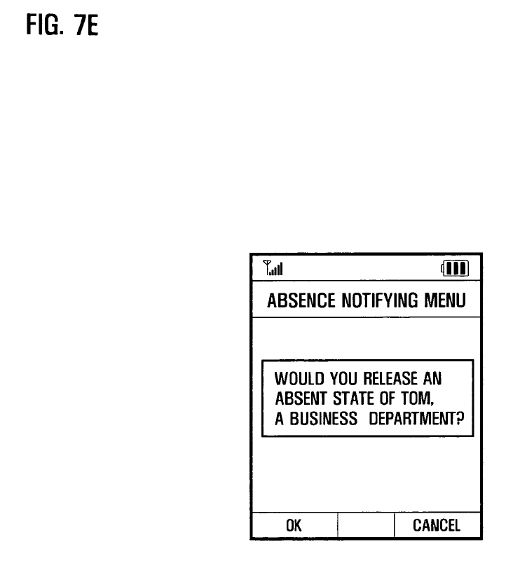

FIG. 7A to FIG. 7E illustrate screens displaying processes as an absent state of a PTT service is notified, according to an embodiment of the present invention.

FIG. 7A illustrates a screen displaying an absence notifying menu, through which an absence notifying message is generated. An input field 800 inputs a called user who is intended to receive an absence notifying message. For example, as shown in FIG. 7A, the input field 800 inputs all members in a “group of business department” and “Tom” as a called user. An input field 702 inputs an absence reasons included in an absence notifying message. The portable terminal user can select one of the previously input absence reasons or arbitrarily input an absence reason. Input fields 703 and 704 input an absence time period included in an absence notifying message. That is, the input field 703 inputs an absence start time and the input filed 704 inputs an absence end time.

FIG. 7B illustrates a screen displaying subscriber information regarding a user of a caller portable terminal where an called portable terminal receives and analyzes an absence notifying message of the caller portable terminal and sets the subscriber information to an absent state. As shown in FIG. 7B, the subscriber information of the user of the caller portable terminal is set to an absent state, and an absence time period is input. This screen configuration can be altered according to the user's purpose or the portable terminal manufacturers'.

FIG. 7C illustrates a screen displaying an absent state indication on the display unit of the called portable terminal when a user of a called portable terminal having an absence notifying message requests a PTT connection from a caller portable terminal having transmitted the absence notifying message.

When a called portable terminal requests a PTT connection from a caller portable terminal, it searches for subscriber information regarding a user of the caller portable terminal, and determines whether the searched subscriber information is set to an absent state. After that, the called portable terminal identifies an absence time period in the searched subscriber information. If the absence time period has not elapsed, the called portable terminal displays an absent state, i.e., an absence reason and an absence time period, on its display unit, as shown in FIG. 7C, so that the user of the called portable terminal can recognize that the user of the caller portable terminal is absent. In that case, the user of the called portable terminal enters an ‘OK’ key to cancel the PTT connection, and then the called portable terminal displays a standby screen.

FIG. 7D illustrates a screen displaying another absent state indication modified from the embodiment of FIG. 7C. The embodiment of FIG. 7D differs from that of FIG. 7C in that, although an absent state indication is output on the display unit, it inquires whether to connect with the other user. That is, although an absence reason of the other user having transmitted an absence notifying message is terminated earlier than the absence time period, if the other user does not transmit an absence releasing message to the user, the subscriber information regarding the other portable terminal user is still in an absent state in the portable terminal. In order to deal with such a case, the embodiment of FIG. 7D is implemented.

FIG. 7E illustrates a screen displaying an absence notifying menu for generating an absence releasing message in a portable terminal having transmitted an absence notifying message. The portable terminal having transmitted an absence notifying message, i.e., a caller portable terminal, activates an absence notifying message menu, generates an absence releasing message to release an absent state, and then transmits it to the PTT server.

As described above, the method for notifying an absent state in a PTT service system, according to the present invention, can allow a portable terminal user to notify the other portable terminal user that he/she is absent, in order to prevent the other portable terminal user from requesting a PTT connection from the portable terminal user, and from wasting time and money on communication charges.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method for notifying an absent state in a Push-To-Talk (PTT) service, the method comprising:
receiving an absence notifying message from a first portable terminal at least one second portable terminal;
setting subscriber information regarding the first portable terminal to an absent state in the second portable terminal; and
displaying the absent state of the first portable terminal in the second portable terminals in the event that the user of the second portable terminal requests a connection with the first portable terminal.

2. The method of claim 1, wherein setting subscriber information regarding the first portable terminal to an absent state, comprises:
searching for subscriber information regarding the user of the first portable terminal in the second portable terminal; and
updating an absent state field in the searched subscriber information based on the received absence notifying message.

3. The method of claim 2, wherein updating an absent state further comprises:
inputting an absence reason and an absence time period, included in the absence notifying message, to the searched subscriber information regarding the first portable terminal.

4. The method of claim 3, wherein displaying the absent state of the first portable terminal further comprises:
determining whether the input absence time period has elapsed; and
displaying the absence reason and the absence time period if the input absence time period has not elapsed.

5. The method of claim 4, further comprising:
releasing the absent state in the subscriber information regarding the first portable terminal, and connecting the second portable terminal to the first portable terminal with a PTT connection service.

6. The method of claim 1, wherein transmitting an absence notifying message from a first portable terminal to at least one or more second portable terminals, further comprises:
releasing the absent state of the subscriber information regarding the first portable terminal by the second portable terminal having the absence releasing message.

7. A Push-To-Talk (PTT) service system comprising:
a first portable terminal the first portable terminal comprises an absence message generating unit operable to transmit an absence notifying message to at least one of a plurality of second portable terminals; and
the plurality of second portable terminals; and
the second portable terminal comprises:
an absent state setting unit operable to set subscriber information regarding the first portable terminal to an absent state if the second portable terminal has received the absence notifying message; and
an absent state controlling unit operable to output an absent state indication of the first portable terminal if the user of the second portable terminal requests a connection from the first portable terminal.

8. The PTT service system of claim 7, wherein the absent state setting unit updates absent state data in subscriber information regarding the user of the first portable terminal, based on the received absence notifying message if the absent state setting unit receives the absence notifying message from the first portable terminal.

9. The PTT service system of claim 8, wherein the absent state setting unit further comprises an input unit operable to input an absence reason and an absence time period, included in the received absence notifying message, to the subscriber information regarding the user of the first portable terminal.

10. The PTT service system of claim 9, wherein the absent state indication further comprises an absence reason and an absence time period.

11. The PTT service system of claim 7, wherein the absence message generating unit transmits an absence releasing message to the at least one or more second portable terminals.

12. The PTT service system of claim 11, wherein the absent state setting unit releases the absent state of the subscriber information regarding the first portable terminal if the absent state setting unit has received the absence releasing message from the first portable terminal.

13. A portable terminal for use in a wireless communications and for supporting a Push-To-Talk (PTT) service, the portable terminal comprising:
a memory adapted to store subscriber information including absent state information, absence reason information, and absence time period information;
an absence message generating unit operable to generate an absence notifying message;
an absent state setting unit operable to set subscriber information regarding other portable terminal, which have transmitted the absence notifying message to the portable terminal, to an absent state if it receiving the absence notifying message; and
an absence state controlling unit operable to output an absent state indication of subscriber information set to an absent state if a user of the portable terminal requests a connection with the other portable terminal whose subscriber information has set to the absent state.

14. The portable terminal of claim 13, wherein the absent state setting unit updates the absent state information, included the subscriber information regarding the other portable terminal having transmitted the absence notifying message, based on the received absence notifying message if the absent state setting unit receives the absence notifying message.

15. The portable terminal of claim 14, wherein the absent state setting unit inputs an absence reason and an absence time period, included in the received absence notifying message, to the subscriber information regarding the other portable terminal having transmitted the absence notifying message.

16. The portable terminal of claim 15, wherein the absent state indication further comprises the input absence reason information and the input absence time period information.

17. The portable terminal of claim 11, wherein the absence message generating unit generates an absence releasing message and transmits it to the portable terminal having received the absence notifying message.

18. The portable terminal of claim 17, wherein the absent state setting unit releases the absent state of the subscriber information if the absent state setting unit has received the absence releasing message.
